(19) United States
(12) Patent Application Publication
(10) Pub. No.: US 2008/0043997 A1
(43) Pub. Date: Feb. 21, 2008

(54) Noise threshold matrix for controlling audio processing

(75) Inventors: Harold Downey, Tempe, AZ (US); Justin L. O'Shea, Gilbert, AZ (US)

Correspondence Address: Paul F. Wille, 6407 East Clinton St., Scottsdale, AZ, 85254, US

(73) Assignee: Acoustic technologies, Inc., Mesa, AZ (US)

(21) Appl. No.: 11/498,010

(22) Filed: Aug. 1, 2006

(51) Int. Cl. H04M 1/00; H04M 9/00

(52) U.S. Cl. 379/392.01

(57) ABSTRACT

A telephone is operated in accordance with a matrix having as one column several zones of noise level, a second column a plurality of thresholds, and having a third column of noise cancellation coefficients. The level of noise in either the receive channel or the transmit channel of the telephone is detected and the telephone is operated in accordance with the data in the row corresponding to the noise level.

### BACKGROUND OF THE INVENTION

This invention relates to a telephone having a loudspeaker and having circuitry for noise reduction and, in particular, to circuitry for controlling and adjusting the circuitry for noise reduction.

As used herein, “telephone” is a generic term for a communication device that utilizes, directly or indirectly, a dial tone from a licensed service provider. As such, “telephone” includes desk telephones (see FIG. 1), cordless telephones (see FIG. 2), speakerphones (see FIG. 3), and hands-free kits (see FIG. 4). For the sake of simplicity, the invention is described in the context of telephones but has broader utility; e.g. intercoms.

There are many sources of noise in a telephone system. Some noise is acoustic in origin while other noise is electronic, from the telephone network, for example. As used herein, “noise” refers to any unwanted sound, whether the unwanted sound is periodic, purely random, or somewhere in-between. As such, noise includes background music, voices of people other than the desired speaker, tire noise, wind noise, and so on. As thus broadly defined, noise could include an echo of the speaker's voice. However, echo cancellation is treated separately in a telephone.

Noise generally has broad spectral content, which can interfere with the intelligibility of a conversation. Another problem with noise is that the spectral content change and the amplitude of the noise can change even during a single telephone call. A vehicle is a particularly difficult environment for these reasons.

There are several techniques for reducing noise. One technique is to subtract a signal representing a noise estimate from the noisy signal. A simpler technique is attenuation, reducing the amplitude of the signal. A problem with noise reduction is that one does not want to reduce a voice signal. Oddly enough, the absence of noise is also a problem because one or both parties may think that the other party has hung up. Thus, many circuits have been developed to provide what is known as “comfort noise,” a low level background noise that is not obtrusive but loud enough for a caller to know that the other party has not hung up.

Thus, there are several problems that must be overcome simultaneously. One is not to confuse voice with noise. Another is not to reduce noise too much. A third is to provide comfort noise only when necessary. A fourth is to perform the necessary corrections in a way that is not noticed by a user.

In view of the foregoing, it is therefore an object of the invention to provide a noise reduction circuit that adapts to noise level to provide an appropriate response.

Another object of the invention is to provide a noise reduction circuit wherein the nature and magnitude of the response depends upon noise level.

A further object of the invention is to provide a noise reduction circuit that implements a defined matrix of noise level and response.

Another object of the invention is to provide a noise reduction circuit that implements a defined matrix of noise level and response, wherein the matrix elements are adjustable.

### SUMMARY OF THE INVENTION

The foregoing objects are achieved in this invention in which a telephone is operated in accordance with a matrix having as one column several zones of noise level, a second column a plurality of thresholds, and having a third column of noise cancellation coefficients. The level of noise in either the receive channel or the transmit channel of the telephone is detected and the telephone is operated in accordance with the data in the row corresponding to the noise level.

### BRIEF DESCRIPTION OF THE DRAWINGS

A more complete understanding of the invention can be obtained by considering the following detailed description in conjunction with the accompanying drawings, in which:

FIG. 1 is a perspective view of a desk telephone;

FIG. 2 is a perspective view of a cordless telephone;

FIG. 3 is a perspective view of a conference phone or a speakerphone;

FIG. 4 is a perspective view of a hands-free kit;

FIG. 5 is a perspective view of a cellular telephone (“cellphone”);

FIG. 6 is a block diagram of the major components of a cellular telephone;

FIG. 7 is a detailed block diagram of an audio processing circuit;

FIG. 8 is a matrix illustrating the operation of an audio processing circuit in accordance with the invention; and

FIG. 9 is a block diagram illustrating a preferred embodiment of the invention.

Those of skill in the art recognize that, once an analog signal is converted to digital form, all subsequent operations can take place in one or more suitably programmed microprocessors. Reference to “signal,” for example, does not necessarily mean a hardware implementation or an analog signal. Data in memory, even a single bit, can be a signal. In other words, a block diagram can be interpreted as hardware, software, e.g. a flow chart or an algorithm, or a mixture of hardware and software. Programming a microprocessor is well within the ability of those of ordinary skill in the art, either individually or in groups.

### DETAILED DESCRIPTION OF THE INVENTION

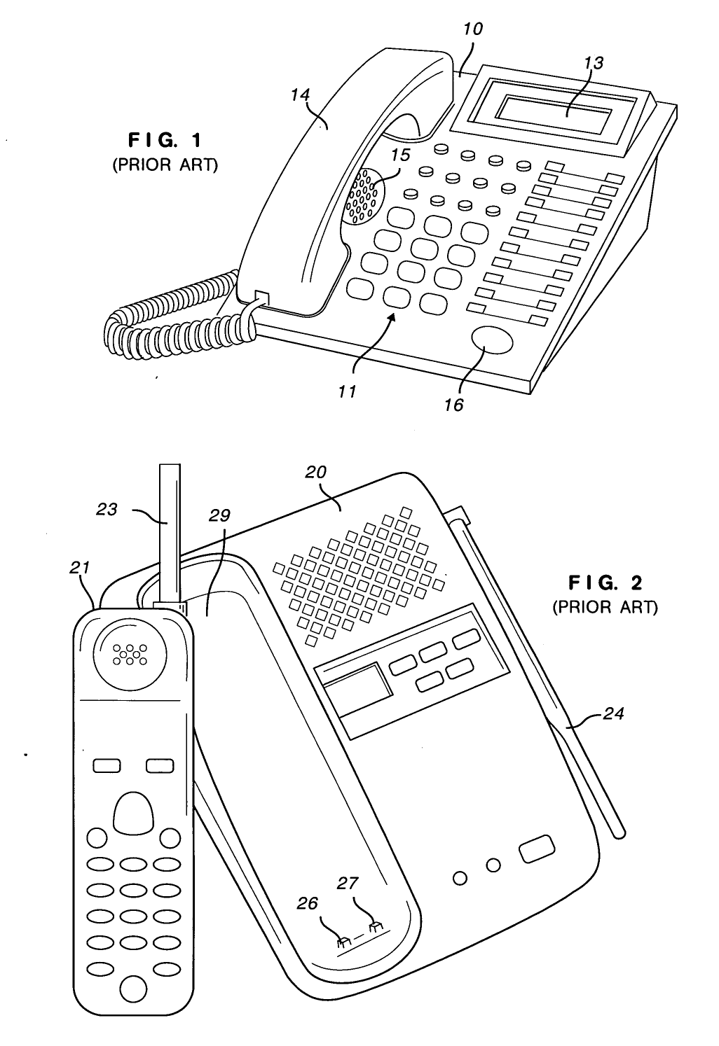

This invention finds use in many applications where the electronics is essentially the same but the external appearance of the device may vary. FIG. 1 illustrates a desk telephone including base 10, keypad 11, display 13 and handset 14. As illustrated in FIG. 1, the telephone has speakerphone capability including loudspeaker 15 and microphone 16. The cordless telephone illustrated in FIG. 2 is similar except that base 20 and handset 21 are coupled by radio frequency signals, instead of a cord, through antennas 23 and 24. Power for handset 21 is supplied by internal batteries (not shown) charged through terminals 26 and 27 in base 20 when the handset rests in cradle 29.

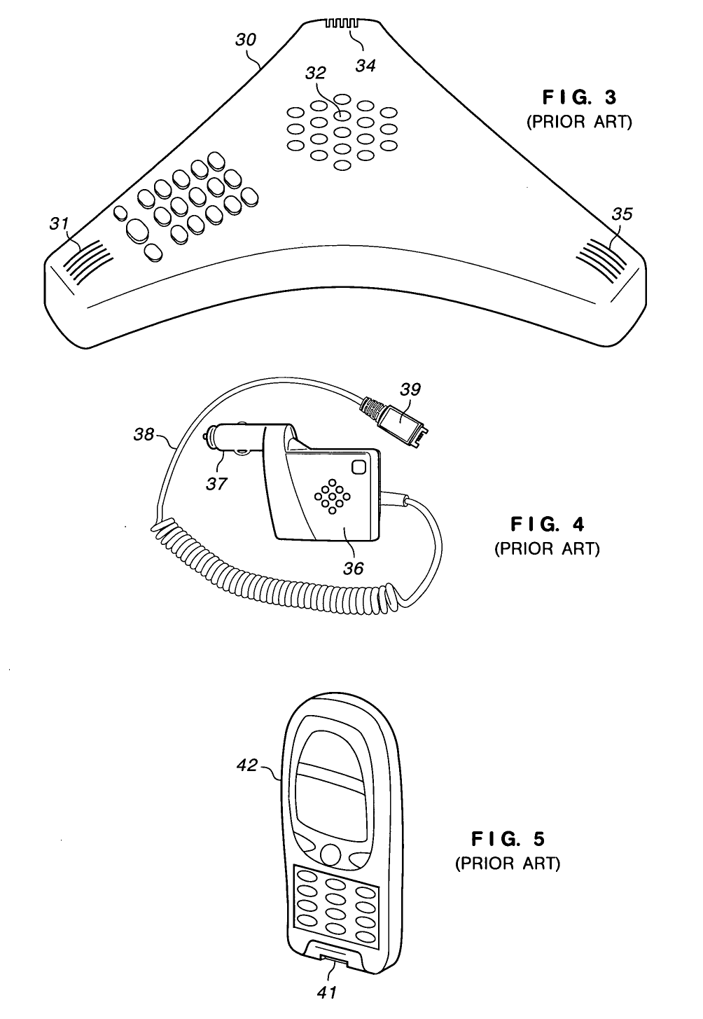

FIG. 3 illustrates a conference phone or speakerphone such as found in business offices. Telephone 30 includes microphone 31 and loudspeaker 32 in a sculptured case. Telephone 30 may include several microphones, such as microphones 34 and 35 to improve voice reception or to provide several inputs for echo rejection or noise rejection, as disclosed in U.S. Pat. No. 5,138,651 (Sudo).

FIG. 4 illustrates what is known as a hands-free kit for providing audio coupling to a cellular telephone, illustrated in FIG. 5. Hands-free kits come in a variety of implementations but generally include powered loudspeaker 36 attached to plug 37, which fits an accessory outlet or a cigarette lighter socket in a vehicle. A hands-free kit also includes cable 38 terminating in plug 39. Plug 39 fits the headset socket on a cellular telephone, such as socket 41 (FIG. 5) in cellular telephone 42. In a sense, a hands-free kit is a special kind of speakerphone and comments relating to one should not be interpreted as excluding the other unless referring to a unique characteristic.

Some hands-free kits use RF signals, like a cordless phone, to couple to a telephone. Some commercially available, hands-free kits use the “BlueTooth®” interface. A hands-free kit also typically includes a volume control and some control switches, e.g. for going “off hook” to answer a call. A hands-free kit may include a visor microphone (not shown) that plugs into the kit.

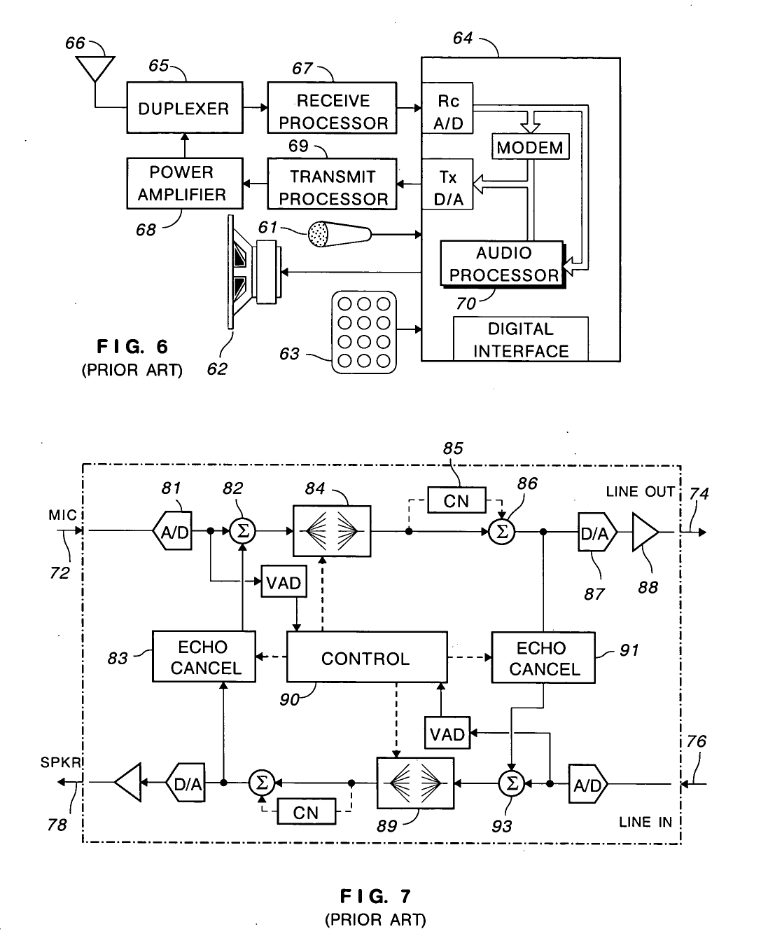

FIG. 6 is a block diagram of the major components of a cellular telephone. Typically, the blocks correspond to integrated circuits implementing the indicated function. Microphone 61, speaker 62, and keypad 63 are coupled to signal processing circuit 64. Circuit 64 performs a plurality of functions and is known by several names in the art, differing by manufacturer. For example, Infineon calls circuit 64 a “single chip baseband IC.” QualComm calls circuit 64 a “mobile station modem.” The circuits from different manufacturers obviously differ in detail but, in general, the indicated functions are included.

A cellular telephone includes both audio frequency and radio frequency circuits. Duplexer 65 couples antenna 66 to receive processor 67. Duplexer 65 couples antenna 66 to power amplifier 68 and isolates receive processor 67 from the power amplifier during transmission. Transmit processor 69 modulates a radio frequency signal with an audio signal from circuit 64. In non-cellular applications, such as speakerphones, there are no radio frequency circuits and signal processor 64 may be simplified somewhat. Problems of echo cancellation and noise remain and are handled in audio processor 70.

FIG. 7 is a detailed block diagram of a noise reduction and echo canceling circuit; e.g. see chapter 6 of Digital Signal Processing in Telecommunications by Shenoi, Prentice-Hall, 1995. The following describes signal flow through the transmit channel, from Mic input 72 to LINE OUT 74. The receive channel, from LINE IN 76 to SPKR output 78, works in the same way.

A new voice signal entering input 72 may or may not be accompanied by a signal from output 78. The signals from input 72 are digitized in A/D converter 81 and coupled to summation network 82. There is, as yet, no signal from echo canceling circuit 83 and the data proceeds to non-linear processor 84, which is initially set to minimum attenuation in all sub-bands.

The output from non-linear processor 84 is coupled to summation circuit 86, where comfort noise 85 is optionally added to the signal. The signal is then converted back to analog form by D/A converter 87, amplified in amplifier 88, and coupled to output 74. Data from the two VAD circuits is supplied to control 90, which uses the data for allocating echo elimination and other functions. The data includes noise level. Circuit 83 reduces acoustic echo and circuit 91 reduces line echo. The operation of these last two circuits is known per se in the art; e.g. as described in the above-identified text.

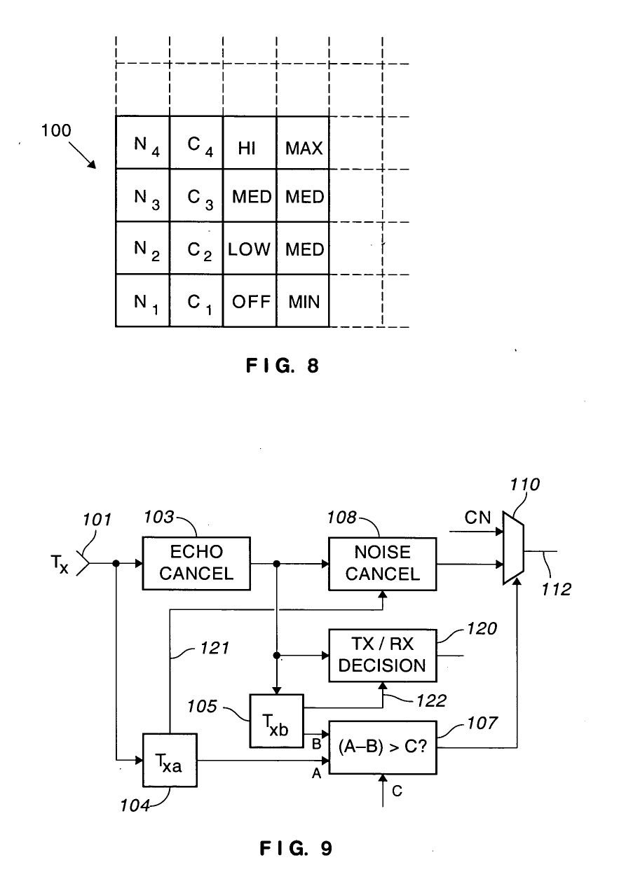

FIG. 8 illustrates a matrix of responses constructed in accordance with the invention. The first column of matrix 100 represents zones of noise level. Although illustrated for the sake of convenience with little squares, the several zones need not be the same size. N₁, N₂, N₃, and N₄ are merely the amplitude that the audio processing circuit can handle divided into four zones (three thresholds). The number of zones is arbitrary.

The second column of the matrix represents a threshold setting for whether or not to switch in comfort noise. As illustrated in FIG. 9, multiplex circuit 110 switches either comfort noise or the output from noise cancellation block 108 to output 112, depending upon the signal from comparator 107. In accordance with the invention, a plurality of thresholds are defined according to noise level. These thresholds are not necessarily related to each other as the noise zones (N4:N3≠C4:C3), although they can be. In other words, the thresholds are arbitrary and, like the noise zones, are tailored to the application; e.g., cellphone, hands-free car kit, and so on. By adjusting the threshold for comfort noise in accordance with the amount of noise, full duplex operation is improved, particularly under low noise conditions.

The third column represents the amount of noise cancellation to apply. This is a system wide control signal represented by the data stored in a register that other parts of the audio processor reference during operation. It can be considered a gain control signal for programmable gain amplifiers or a coefficient by which digital signals are multiplied to change the magnitude thereof. By adjusting the amount of noise cancellation in accordance with the amount of noise present, voice clarity can be optimized across the full range of telephone set noise.

The fourth column represents transmit bias attenuation. This is the fractional gain (0≦x≦1) or bias attenuation that is coupled to receive/transmit state decision logic. As indicated by matrix 100, the amount of attenuation varies with noise level. As with the other parameters, there need not be a linear relationship between noise level and bias attenuation.

Transmit bias attenuation has been divided into three levels, despite the fact that there are four zones of noise. This is one of the advantages of the invention in that the matrix control is flexible. One is not obliged to provide four levels attenuation, even though there are four zones of noise. Three levels has been found suitable and, therefore, two of the entries are the same in the right hand most column.

As illustrated in FIG. 9, input 101 is coupled to echo canceling circuit 103 and amplitude detector 104. The output of echo canceling circuit 103 is coupled to the input of amplitude detector 105. The output from detector 104 is coupled to the A input of comparator 107. The output from detector 105 is coupled to the B input of comparator 107, which subtracts the signals on the inputs and compares the difference with variable threshold, C.

If the difference is less than C, this is interpreted as speech and multiplex circuit 110 couples the output from noise cancellation block 108 to output 112. If the difference is greater than C, this is interpreted as non-speech and multiplex circuit 110 couples comfort noise CN to output 112.

The amount of noise cancellation is adjusted according to the amount of noise, columns one and three of the matrix. Detector 104 provides an ambient noise level signal on line 121 to adjust noise cancellation circuit 108. This signal is not the same as the signal at A but is a longer term average of noise level. Similarly, detector 105 provides a longer term average signal on line 122 to decision circuit 120 in accordance with columns one and four of the matrix.

The invention thus provides a noise reduction circuit that adapts to noise level to provide an appropriate response, wherein the nature and magnitude of the response depends upon noise level. A number of variables are organized in a matrix according to noise level, wherein the matrix elements are adjustable. The invention thus provides a complex, yet easily implemented noise reduction that is easily adapted to particular applications and hardware by changing the values in storage registers.

Having thus described the invention, it will be apparent to those of skill in the art that various modifications can be made within the scope of the invention. For example, while a 4×4 matrix has been shown and described, a matrix having different dimensions can be used as well. Although reference is made to “amplitude” for ease of discussion, energy could be calculated instead.

What is claimed as the invention is:

1. A method for operating an audio processor having noise reduction circuitry, said method comprising the steps of:
defining a matrix having as one column several zones of noise level, a second column a plurality of thresholds, and having a third column of noise cancellation coefficients;
detecting the level of noise in a signal in the audio processor; and
operating the audio processor in accordance with the matrix.

2. The method as set forth in claim 1, wherein said audio process or includes a comfort noise generator, and further including the step of:
adjusting a threshold for inserting comfort noise in accordance with the matrix.

3. The method as set forth in claim 1 and further including the step of:
controlling the amount of noise cancellation in accordance with the matrix.

4. The method as set forth in claim 1 and further including the step of:
controlling the sensitivity of a receive/transmit state decision to the transmit signal in accordance with the matrix.

5. The method as set forth in claim 1 wherein the matrix is 4×4.

6. The method as set forth in claim 5 wherein the same entry appears more than once in a column of the matrix.

7. A method for operating a telephone having an echo cancelling circuit and a comfort noise generator, said method comprising the steps of:
subtracting the amplitude of a signal at the output of the echo cancelling circuitry from a signal at the input of the echo cancelling circuit;
comparing the difference with a threshold;
coupling either the echo cancelling circuit or the comfort noise generator to an output depending upon the result of the comparison.

8. The method as set forth in claim 7 wherein said telephone further includes a noise cancelling circuit coupled to the output of the echo cancelling circuit and further including the steps of:
defining a matrix having as one column several zones of noise level, a second column a plurality of thresholds, and having a third column of noise cancellation coefficients;
calculating average signal amplitude at the input of the echo cancelling circuit;
controlling the noise cancelling circuit in accordance with the matrix.
